(19) United States
(12) Patent Application Publication
(10) Pub. No.: US 2016/0084327 A1
(43) Pub. Date: Mar. 24, 2016

(54) METHOD FOR SEARCHING FOR TOUCH POINT OF DRY TYPE CLUTCH

(71) Applicant: Hyundai Motor Company, Seoul (KR)

(72) Inventors: Young Min YOON, Suwon-si (KR); Hyung Wook CHO, Ansan-si (KR)

(73) Assignee: Hyundai Motor Company, Seoul (KR)

(21) Appl. No.: 14/559,196

(22) Filed: Dec. 3, 2014

(30) Foreign Application Priority Data
Sep. 23, 2014 (KR) 10-2014-0126597

(51) Int. Cl. F16D 48/06

(52) U.S. Cl. CPC F16D 48/064; F16D 2121/18

(57) ABSTRACT

Disclosed are methods for searching for a touch point of a dry type clutch. A method may include starting monitoring of current that is consumed in an actuator while driving the actuator in a direction in which the clutch is engaged from a release state, calculating a force that is applied to an engagement bearing of the clutch from the current that is consumed in the actuator after the starting monitoring of the current, determining whether the calculated force exceeds a predetermined reference force, and determining an actuator stroke when the calculated force starts to exceed the predetermined reference force as the touch point.

### CROSS-REFERENCE TO RELATED APPLICATIONS

The present application claims priority of Korean Patent Application Number 10-2014-0126597 filed on Sep. 23, 2014, the entire contents of which are incorporated herein for all purposes by this reference.

### BACKGROUND OF THE INVENTION

1. Field of the Invention

The present invention relates to a method for searching for a touch point of a dry type clutch, and more particularly, to a method for finding a touch point of a dry type clutch used in an AMT or a DCT.

2. Description of Related Art

A DCT (Double Clutch Transmission) or an AMT (Automated Manual Transmission) is a system which automatically controls a manual transmission mechanism, and is mainly configured to transfer an engine torque to a transmission mechanism using a dry type clutch unlike a typical Automatic Transmission that uses a torque converter and a wet type multiplate clutch.

The dry type clutch is controlled by an actuator, and the actuator is normally controlled by a T-S curve that indicates a change of transferred torque of the dry type clutch with respect to a stroke of the actuator.

In the dry type clutch, the transferred torque of the dry type clutch according to the stroke of the actuator is greatly changed due to a large number of factors, such as abrasion caused by component tolerances of constituent elements and durable proceedings, thermal deformation due to temperatures, and change of frictional coefficients of a disk. Unless the change of the transferred torque is appropriately corrected, an abrupt slip may occur in the dry type clutch to deteriorate durability or to cause gear shift impacts to occur.

Accordingly, a controller that controls the actuator should have accurate information on the transferred torque characteristics of the dry type clutch according to the actuator stroke. However, since the characteristics of the dry type clutch are continuously changed according to the traveling situations of the vehicle, there is a need for a method for correcting such information to correct values at proper times. In particular, it is necessary for the controller to accurately find and correct the touch point that means the actuator stroke at a time when a frictional force starts to be generated in a power release state of the dry type clutch.

The information disclosed in this Background section is only for enhancement of understanding of the general background of the invention and should not be taken as an acknowledgement or any form of suggestion that this information forms the prior art already known to a person skilled in the art.

### SUMMARY OF THE INVENTION

The present invention is directed to a method for searching for a touch point of a dry type clutch, which can accurately and easily find a touch point of a dry type clutch regardless of temperature change of the dry type clutch that occurs during traveling of a vehicle, and can appropriately control the dry type clutch to improve shift quality and durability of the dry type clutch.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with various aspects of the present invention, a method for searching for a touch point of a dry type clutch includes: starting monitoring of current that is consumed in an actuator while driving the actuator in a direction in which the clutch is engaged from a release state; calculating a force that is applied to an engagement bearing of the clutch from the current that is consumed in the actuator after the starting monitoring of the current; determining whether the calculated force exceeds a predetermined reference force; and determining an actuator stroke when the calculated force starts to exceed the predetermined reference force as the touch point.

In accordance with various other aspects of the present invention, a method for searching for a touch point of a dry type clutch includes: starting monitoring of current that is consumed in an actuator while driving the actuator in a direction in which the clutch is engaged from a release state; determining whether the current that is consumed in the actuator exceeds a predetermined reference current after the starting monitoring of the current; and determining an actuator stroke when the consumed current starts to exceed the predetermined reference current as the touch point.

According to the present invention, the touch point of the dry type clutch can be accurately and easily found regardless of the temperature change of the dry type clutch that occurs during traveling of a vehicle, and the dry type clutch can be appropriately controlled to improve the shift quality and durability of the dry type clutch.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart illustrating an exemplary method for searching for a touch point of a dry type clutch in accordance with the present invention.

FIG. 2 is a graph illustrating a change of a transferred torque of a dry type clutch with respect to an actuator stroke in accordance with a temperature change of the dry type clutch.

FIG. 3 is a graph illustrating a change of a transferred torque of a dry type clutch with respect to a force that is applied to an engagement bearing of an actuator in accordance with a temperature change of the dry type clutch.

FIG. 4 is a diagram explaining the principle of the present invention.

### DESCRIPTION OF SPECIFIC EMBODIMENTS

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

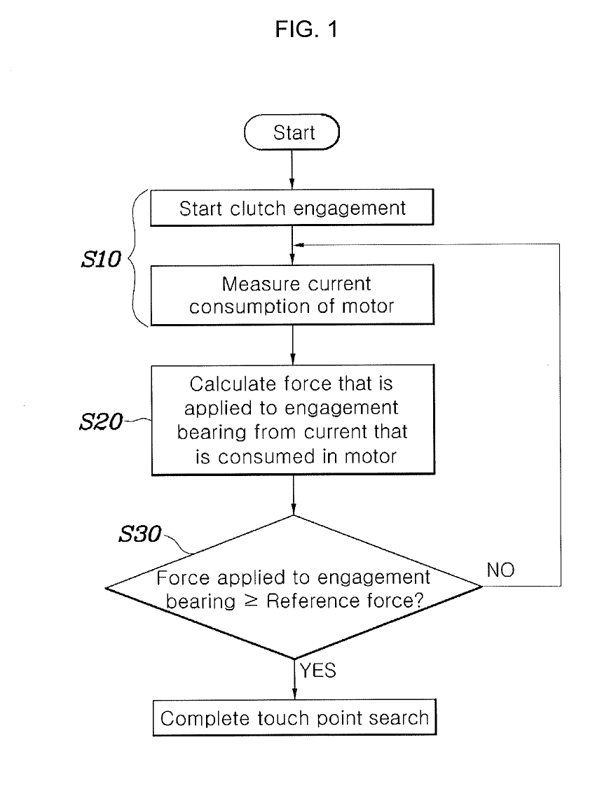

Referring to FIG. 1, a method for searching for a touch point of a dry type clutch in accordance with various exemplary embodiments of the present invention includes starting monitoring of current that is consumed in an actuator while driving the actuator in a direction in which the clutch is engaged from a release state (S10); calculating a force that is applied to an engagement bearing of the clutch from the current that is consumed in the actuator (S20) after the starting the current monitoring (S10); and determining whether the calculated force exceeds a predetermined reference force (S20), and determining an actuator stroke when the calculated force starts to exceed the predetermined reference force as the touch point (S30).

The predetermined reference force is set in advance as a force that is applied to an engagement bearing of the clutch at the touch point, for example, through a plurality of experiments.

That is, in the related art, the touch point of the dry type clutch is determined from the relationship between the stroke change of the actuator and the transferred torque change. According to the present invention, the touch point of the dry type clutch is determined from the relationship between the force that actually acts on the engagement bearing of the dry type clutch according to the operation of the actuator and the transferred torque change of the dry type clutch.

For reference, the engagement bearing is a part that serves to overcome the force of a spring in the dry type clutch and to engage the dry type clutch by the force that is provided from the actuator, and the controller is configured to include a current sensor that can measure the current that is consumed in the actuator or to receive the signal from an external current sensor.

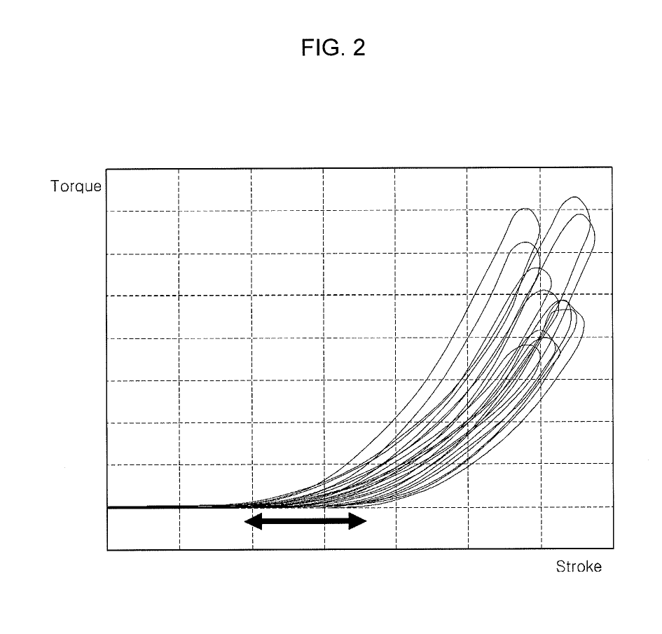

FIG. 2 illustrates a change of a transferred torque of a dry type clutch with respect to an actuator stroke in accordance with a temperature change of the dry type clutch. Respective curves indicate that the transferred torque is increased as the actuator stroke is increased when the dry type clutch is at a specific temperature.

Here, the touch point is a point at which the transferred torque starts to be increased from 0 as the actuator stroke is increased. The curves, which indicate the transferred torque characteristics at different dry type clutch temperatures, indicate that the transferred torque starts to be increased over 0 at different actuator strokes, and as a result, the touch point is greatly changed according to the temperature change of the dry type clutch. For reference, in the drawing, arrows indicate the change of the touch point according to the temperature change of the dry type clutch as described above.

In the related art, the touch point of the dry type clutch is searched for only from the relationship between the actuator stroke change and the transferred torque change. However, the touch point is greatly changed according to the temperature change of the dry type clutch as illustrated in FIG. 2, and if the dry type clutch, of which the temperature is diversely changed during the traveling of the vehicle, is controlled by the touch point that is obtained by the method in the related art, there is a high possibility that an inappropriate control is performed.

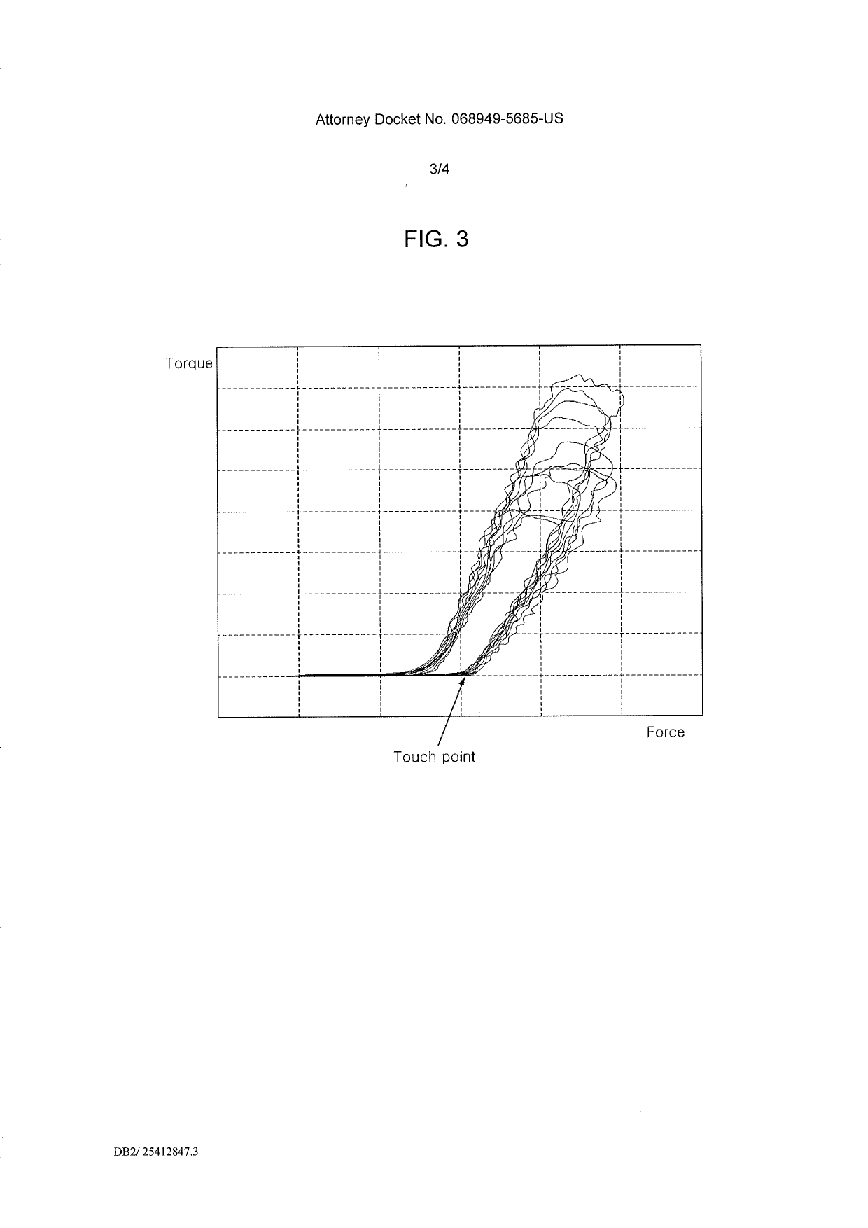

In contrast, FIG. 3 illustrates a change of a transferred torque of a dry type clutch with respect to a force that is applied to an engagement bearing of an actuator in accordance with a temperature change of the dry type clutch. As shown in FIG. 3, as the force that is applied to the engagement bearing is increased, the point at which the transferred torque starts to be increased from 0 is almost constant.

In controlling the dry type clutch through the control of the actuator, the controller searches for the touch point with respect to the force that is applied to the engagement bearing, and controls the dry type clutch according to the searched touch point. Accordingly, the control of the dry type clutch can be performed more accurately.

Here, since the force that is applied to the bearing is in proportion to the current that is consumed in a motor having the actuator, according to the present invention, the force that is applied to the engagement bearing is calculated from the current that is consumed in the actuator (S20), and the calculated force is compared with the reference force and the position in which the calculated force exceeds the reference force is determined as the touch point.

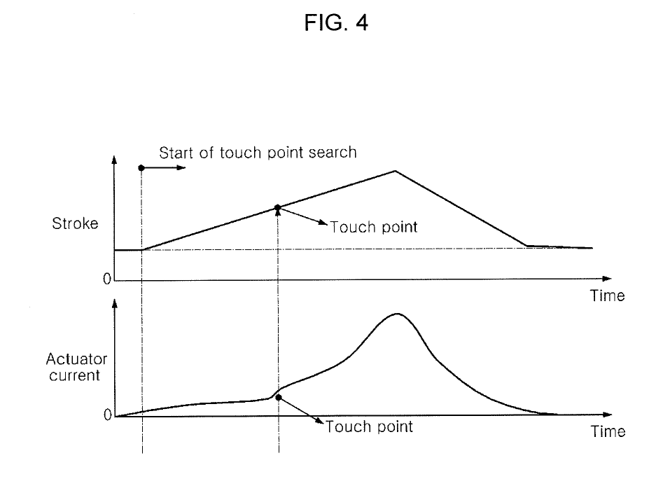

FIG. 4 is a diagram explaining the principle of the present invention. FIG. 4 illustrates that while the actuator stroke is gradually increased with the start of a search for the touch point, the current that is consumed in the actuator is abruptly increased at the touch point. In accordance with the relationship as described above, the touch point can be searched for in the same method as described above.

Another embodiment of the present invention may be derived from the relationship of FIG. 4. A method for searching for a touch point of a dry type clutch in accordance with another exemplary embodiment of the present invention includes starting monitoring of current that is consumed in an actuator while driving the actuator in a direction in which the clutch is engaged from a release state; and determining whether the current that is consumed in the actuator exceeds a predetermined reference current after the starting the current monitoring, and determining an actuator stroke when the consumed current starts to exceed the predetermined reference current as the touch point.

The predetermined reference current is set in advance as the current that is consumed in the actuator at the touch point, for example, through a plurality of experiments.

In some embodiments such as that illustrated in FIG. 1, the force is calculated from the current, and the calculated force is compared with the reference force. In some embodiments, the process of calculating the force from the current is omitted, and the touch point is determined by directly comparing the current being consumed with the reference current.

According to the present invention as described herein, since the touch point of the dry type clutch can be searched for and determined more accurately and reliably through the relationship between the force that acts on the engagement bearing and the generation of the transferred torque, the subsequent control of the dry type clutch through the actuator based on this can be performed more accurately to prevent the gear shift impacts and to improve the durability of the dry type clutch.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for searching for a touch point of a dry type clutch, comprising:
starting monitoring of current that is consumed in an actuator while driving the actuator in a direction in which the clutch is engaged from a release state;
calculating a force that is applied to an engagement bearing of the clutch from the current that is consumed in the actuator after the starting monitoring of the current;
determining whether the calculated force exceeds a predetermined reference force; and
determining an actuator stroke when the calculated force starts to exceed the predetermined reference force as the touch point.

2. The method of claim 1, wherein the predetermined reference force is set in advance as a force that is applied to the engagement bearing of the clutch at the touch point through a plurality of experiments.

3. A method for searching for a touch point of a dry type clutch, comprising:
starting monitoring of current that is consumed in an actuator while driving the actuator in a direction in which the clutch is engaged from a release state;
determining whether the current that is consumed in the actuator exceeds a predetermined reference current after the starting monitoring of the current; and
determining an actuator stroke when the consumed current starts to exceed the predetermined reference current as the touch point.

4. The method of claim 3, wherein the predetermined reference current is set in advance as the current that is consumed in the actuator at the touch point through a plurality of experiments.
